(19) United States
(12) Patent Application Publication
(10) Pub. No.: US 2026/0339776 A1
(43) Pub. Date: Oct. 29, 2026

(54) UNIVERSAL FLASH STORAGE USER MONITORING INTERFACE

(71) Applicant: Micron Technology, Inc., Boise, ID (US)

(72) Inventor: Rainer Frank BONITZ, Bruckmühl (DE)

(21) Appl. No.: 19/555,599

(22) Filed: Mar. 3, 2026

Related U.S. Application Data
(60) Provisional application No. 63/796,012, filed on Apr. 28, 2025.

(51) Int. Cl. G06F 11/10; G06F 11/14; G06F 11/30

(52) U.S. Cl. CPC G06F 11/1016; G06F 11/1441; G06F 11/3037

(57) ABSTRACT

In some implementations, a device may receive, via a plurality of vendor specific function (VSF) pins, an indication of monitoring. The device may output, via a first subset of the VSF pins, an indication of a transmission speed associated with a device. In some aspects, the device may output, via a second subset of the VSF pins, an indication of a status of an initialization procedure. The device may output, via a third subset of the VSF pins, an indication of whether a latest read operation included an uncorrectable error correction code (UECC) occurrence. The device may output, via a fourth subset of the VSF pins, an indication of an address range corresponding to the latest read operation or a latest write operation. The device may output, via a fifth subset of the VSF pins, an indication of a command status associated with data being transmitted.

### CROSS-REFERENCE TO RELATED APPLICATION

This Patent Application claims priority to U.S. Provisional Patent Application No. 63/796,012, filed on Apr. 28, 2025, entitled “UNIVERSAL FLASH STORAGE USER MONITORING INTERFACE,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to a universal flash storage user monitor interface.

### BACKGROUND

A non-volatile memory device, such as a NAND memory device, may use circuitry to enable electrically programming, erasing, and storing of data. For example, in contrast to volatile memory devices such as a dynamic random access memory (DRAM) memory device, storing of data in non-volatile memory devices is maintained even when a power source is not supplied or becomes disconnected. Non-volatile memory devices may be used in various types of electronic devices, such as computers, mobile phones, or automobile computing systems, among other examples.

A non-volatile memory device may include an array of memory cells, a page buffer, and a column decoder. In addition, the non-volatile memory device may include a control logic unit (e.g., a controller), a row decoder, or an address buffer, among other examples. The memory cell array may include memory cell strings connected to bit lines, which are extended in a column direction.

A memory cell, which may be referred to as a “cell” or a “data cell,” of a non-volatile memory device may include a current path formed between a source and a drain on a semiconductor substrate. The memory cell may further include a floating gate and a control gate formed between insulating layers on the semiconductor substrate. A programming operation (sometimes called a write operation) of the memory cell is generally accomplished by grounding the source and the drain areas of the memory cell and the semiconductor substrate of a bulk area, and applying a high positive voltage, which may be referred to as a “program voltage,” a “programming power voltage,” or “VPP,” to a control gate to generate Fowler-Nordheim tunneling (referred to as “F-N tunneling”) between a floating gate and the semiconductor substrate. When F-N tunneling is occurring, electrons of the bulk area are accumulated on the floating gate by an electric field of VPP applied to the control gate to increase a threshold voltage of the memory cell.

An erasing operation of the memory cell is concurrently performed in units of sectors sharing the bulk area (referred to as “blocks”), by applying a high negative voltage, which may be referred to as an “erase voltage” or “Vₑᵣₐ,” to the control gate and a configured voltage to the bulk area to generate the F-N tunneling. In this case, electrons accumulated on the floating gate are discharged into the source area, so that the memory cells have an erasing threshold voltage distribution.

Each memory cell string may have a plurality of floating gate type memory cells serially connected to each other. Access lines (sometimes called “word lines”) are extended in a row direction, and a control gate of each memory cell is connected to a corresponding access line. A non-volatile memory device may include a plurality of page buffers connected between the bit lines and the column decoder. The column decoder is connected between the page buffer and data lines.

### BRIEF DESCRIPTION OF THE DRAWINGS

FIG. 1 is a diagram illustrating an example system with a universal flash storage (UFS) user monitoring interface.

FIG. 2 is a diagram of an example of a device that supports a UFS user monitoring interface.

FIG. 3 is a diagram of an example of monitoring information output via a set of vendor specific function pins.

FIGS. 4 through 6 are flowcharts of example methods associated with a UFS user monitoring interface.

### DETAILED DESCRIPTION

Some devices, such as universal flash storage (UFS) devices may include a vendor specific function (VSF) interface, which may allow a host device to interface with a UFS device. In some examples, the VSF interface may include one or more VSF input/output (I/O) pins that may allow the host device to communicate with the UFS device for different functions. For example, some UFS devices may use the VSF I/O pins as a debug interface, which may allow failure analysis in error cases. In some examples, the functionality of the VSF interface may be flexible, and may vary between different device manufacturers.

In some cases, it may be desirable to obtain information associated with the UFS device while the UFS device is operating, which may be used for troubleshooting, device analysis, or identification of defects associated with the UFS device. For example, device analysis may be used to generate a boot sequence timetable that identifies different stages of a boot sequence (e.g., associated with accessing different logical units (LUs)), which may aid in evaluating a performance or identifying potential defects associated with the UFS device. In some cases, external test devices such as oscilloscopes may be used to analyze processes being performed by the UFS device, such as during a boot sequence to create the boot sequence timetable. Some UFS devices may operate at relatively fast speeds, however, and test devices that can operate at sampling frequencies that are sufficient to analyze the operations performed by these UFS devices may be costly and may be inaccessible to users. Additionally, even with test devices, detecting issues such as uncorrectable error correction code (UECC) occurrences or verifying the boot sequence of a system during runtime can be challenging without direct access to the relevant UFS device signals. For example, a UECC occurrence may refer to when error correcting code that identifies errors in data cannot correct a detected data error.

Accordingly, some aspects described herein relate to techniques for a device (e.g., a UFS device) to output monitoring information via the VSF interface. For example, one or more VSF pins (e.g., VSF I/O pins) may be configured to output monitoring information associated with the device, such as a transmission speed (e.g., a gear status), an address range of a most recent read or write operation, a current command status, an indication of whether an initialization procedure has been completed, an indication of whether a most recent read operation included a UECC occurrence, or other information. In some aspects, the VSF pins may be configured to output the monitoring information when a reset signal from the host device to the device is asserted (e.g., is set to a low state). Additionally, or alternatively, the host device may transmit a signal via one or more VSF pins that enables a monitoring mode where the device may output the monitoring information via the VSF pins. In some aspects, the host device may be configured to transmit an indication of monitoring information to be output by the device via one or more VSF pins. Accordingly, the VSF interface may be configured to provide real-time status information, which may facilitate external analysis of UFS device behavior and performance without the need for additional complex or costly diagnostic tools.

The techniques described herein may additionally be used to provide benefits in the context of edge computing, where reliable and efficient data storage is critical for the performance of edge devices. For example, by enabling UFS devices to output real-time status information via VSF pins, these techniques may facilitate external analysis of device behavior and performance without the need for costly diagnostic tools. As such, the described techniques may be particularly valuable for edge applications, where quick and precise identification of operational anomalies can prevent system downtime and ensure continuous operation. Additionally, the ability to monitor critical parameters such as transmission rates, command status, and data integrity supports efficient troubleshooting and maintenance of edge devices. The incorporation of an indication associated with UECC occurrences further enhances system resilience, allowing for immediate response to data integrity issues. Overall, the invention contributes to the robustness and reliability of edge computing systems by providing accessible and cost-effective diagnostic capabilities.

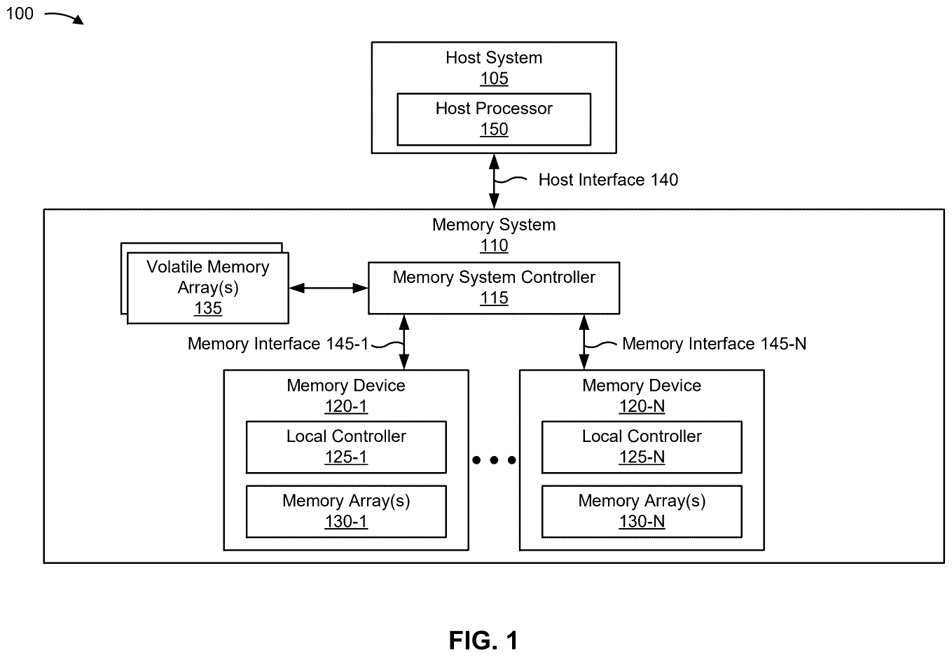

FIG. 1 is a diagram illustrating an example system 100 a UFS user monitoring interface. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive an indication of a device reset signal; receive, via a plurality of VSF pins, an indication of monitoring associated with the device; and output, via the plurality of VSF pins, status information associated with the device in accordance with the device reset signal and the indication of the monitoring.

In some implementations, one or more systems, devices, apparatuses, components, and/or controllers of FIG. 1 may be configured to transmit an indication of a device reset signal; transmit, via a plurality of VSF pins, an indication of monitoring; and output, via the plurality of VSF pins, status information associated with the device in accordance with the device reset signal and the indication of the monitoring.

In some implementations, one or more systems, devices, apparatuses, components, and/or controllers of FIG. 1 may be configured to receive, via a plurality of VSF pins, an indication of monitoring; output, via a first subset of the plurality of VSF pins, an indication of a transmission speed associated with a device; output, via a second subset of the plurality of VSF pins, an indication of a status of an initialization procedure; and output, via a third subset of the plurality of VSF pins, an indication of whether a latest read operation included an UECC occurrence.

In some implementations, one or more systems, devices, apparatuses, components, and/or controllers of FIG. 1 may be configured to receive an indication of a reset state; and receive, via a plurality of VSF pins, an indication of monitoring; and output, via the plurality of VSF pins, status information associated with the memory device in accordance with the indication of the reset state and the indication of the monitoring.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

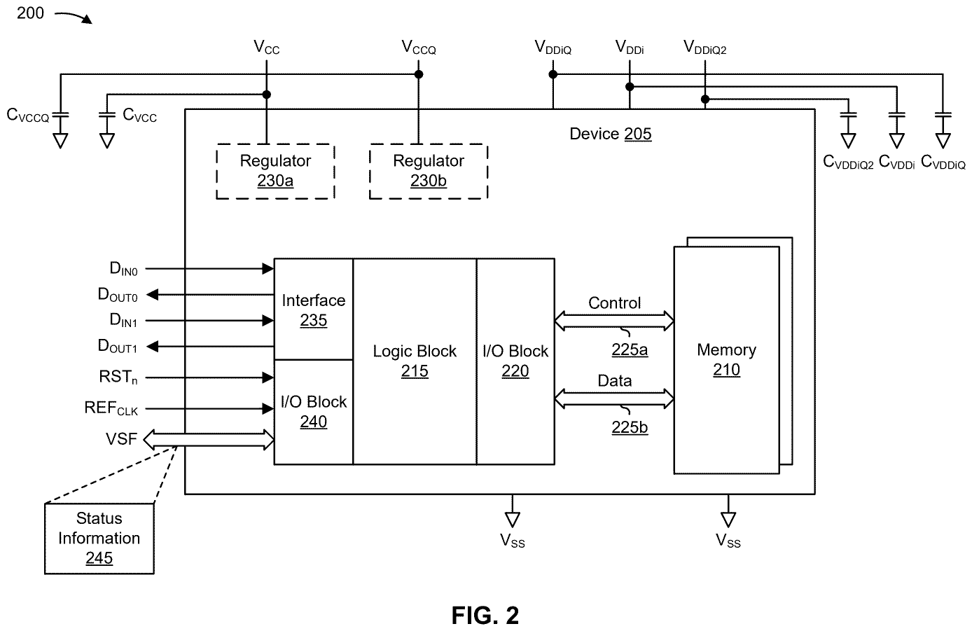

FIG. 2 is a diagram of an example 200 of a device 205 that supports a UFS user monitoring interface. The device 205 may include a memory 210 (e.g., NAND flash memory, or memory arrays 130). The operations described in connection with FIG. 2 may be performed by the memory system 110 and/or one or more components of the memory system 110, such as the memory system controller 115, one or more memory devices 120, and/or one or more local controllers 125.

The device 205 may include a logic block 215 (e.g., a local controller 125) that may manage operations and functions of the device 205. The device 205 may additionally include an I/O block 220 coupled with the logic block 215 and connected to the memory 210 via one or more control lines 225a and one or more data lines 225b, facilitating read and write operations for the memory 210. The device 205 may include a regulator 230a associated with regulating a supplied voltage V_{cc} (e.g., a supply voltage from C_{VCC} for the device 205) and a regulator 230b associated with regulating a voltage V_{CCQ} (e.g., a supply voltage from C_{VCCQ}for one or more controllers, interfaces, memory I/O, or low voltage blocks of the device 205). In some examples, the device may include one or more input terminals for voltages, such as V_{DDiQ}, V_{DDi}, and V_{DDiQ2}, associated with providing a bypass capacitor for one or more internal voltage regulators (e.g., C_{VDDiQ}, C_{VDDi}, and C_{VDDiQ2}).

The device 205 may include an interface 235, which may be configured to support communication with a host device. In some examples, the interface 235 may include one or more data-in lines, such as D_{IN0} and D_{IN1}, that may allow the host device to send data to the memory device for storage or processing. Additionally, the interface 235 may include one or more data-out lines, such as D_{OUT0} and D_{OUT1}, that may enable the memory device to transmit data back to the host device (e.g., during a read operation). This bidirectional data flow ensures efficient data exchange and supports various read and write operations, enhancing the overall functionality and performance of the memory device in its applications. In some cases, such as when the device is a UFS device, the interface 235 may be an example of a mobile industry processor interface (MIPI) physical (M-PHY) block (e.g., an interface block complying with a an M-PHY communications protocol).

In some examples, the device 205 may include an I/O block 240. The I/O block 240 may be configured to receive a reset signal (shown as RSTn) as an input (e.g., from the host device), which may be a hardware reset signal. In some examples, the reset signal may be an active low signal (e.g., may be asserted when a low signal is input). Additionally, the I/O block 240 may be configured to receive a reference clock signal (shown as REFCLK) as an input from the host device. In some cases, the reference clock signal may be pulled down (e.g., driven to a low signal) by the host device when the reference clock signal is not in use. Additionally, the I/O block 240 may include one or more VSF pins.

In some aspects, the device 205 may be configured to output status information 245 via the one or more VSF pins. In some examples, the device 205 may output the status information 245 when a monitoring mode (e.g., a user monitoring mode) is initiated. For example, the device 205 may receive, via the one or more VSF pins, an indication of the monitoring mode (e.g., an indication of monitoring). In some aspects, to transmit the indication of the monitoring mode, the host device may pull a combination of the one or more VSF pins to a first value (e.g., a high signal), to a second value (e.g., a low signal), or a combination thereof, which may activate an integrated monitor circuit within the device 205 and initiate the monitoring mode. Additionally, or alternatively, the monitoring mode may be initiated based on the device 205 receiving the reset signal (e.g., the reset signal being pulled low). For example, the reset signal may serve as a trigger for the device to prepare for various operations, including entering a monitoring mode (e.g., in addition to or alternative to receiving the indication of the monitoring mode via the one or more VSF pins).

In some aspects, the status information 245 may include an indication of an interface gear status corresponding to a transmission rate of the device 205. For example, the interface gear status may indicate a transmission speed of the device 205 (e.g., of the interface 235, the data signals 225b, or the control signals 225a). In some cases, the interface gear status may indicate whether the device 205 is operating in a single transmission mode or a dual transmission mode. For example, the gear status may include a Gear1 mode, a Gear2 mode, a Gear3 mode, a Gear4x1 mode, a Gear4x2 mode, a Gear5x1 mode, a Gear5x2 mode, or other modes. In some examples, a lower interface gear status (e.g., the Gear1 mode) may correspond to a lower transmission speed than higher gear modes (e.g., Gear5 modes). Additionally, or alternatively, the gear status mode may correspond to a pulse width modulation (PWM) mode, where values may be output in accordance with a width of pulses in the transmitted signal.

In some aspects, the status information 245 may include an indication of an address range corresponding to a latest read operation. Additionally, or alternatively, the status information 245 may include an indication of an address range corresponding to a latest write operation. In some aspects, the address range may be selected from a set of address ranges associated with the memory 210. For example, the set of address ranges may include address ranges associated with one or more boot LUs, such as a boot LU A and a boot LU B of the memory 210. Additionally, or alternatively, the set of address ranges may include address ranges associated with replay protected memory of the memory 210 or one or more user area LUs of the memory 210. Accordingly, the status information 245 may be used to identify which LUs are being accessed, which may indicate a current stage of a boot sequence and allow users to monitor and assess boot process efficiency and troubleshoot any delays or issues.

In some aspects, the status information 245 may include an indication of a command status associated with a command being performed by the device 205 or data being transmitted by the device 205 (e.g., via the interface 235 or the I/O block 220). For example, the command status may indicate whether a read command, a write command, another command, or no command is currently being performed by the device 205. Additionally, or alternatively, the command status may indicate whether data being transmitted (e.g., via one or more data-out lines of the interface 235 or via the control lines 225a or the data lines 225b) corresponds to a read command, a write command, or another command, or that there is no data transmission occurring.

In some aspects, the status information 245 may include an indication of a completion status associated with an initialization phase of the device 205. For example, the device 205 may output, via at least one VSF pin, a device initialization flag (e.g., an fDeviceinit flag) that indicates whether the initialization phase has been completed and the device is ready to accept a command from the host device.

In some aspects, the status information 245 may include an indication of UECC information. For example, the status information 245 may indicate whether a latest read operation included a UECC occurrence. By outputting information indicating whether a last read operation was affected by a UECC occurrence, the device 205 may provide information for the detection and analysis of data integrity issues, which may be useful for functional safety applications where data reliability may be important. “In some cases, the UECC output signal may be used as a hardware interrupt input for the device 205 (or a system including the device, such as the memory system 110). For example, the hardware interrupt may allow a user to respond to data integrity issues, enhancing the overall functional safety of the system by enabling real-time error handling and corrective actions.

In some aspects, the status information 245 to be output via the VSF pins by the device 205 may be indicated by the host device. For example, the host device may indicate, via at least one VSF pin, a type of information to be output via the VSF pins by the device 205. In some cases, the type of information may be selected from a set of information types, which may indicate the information that should be output by the device 205. Accordingly, the host device may configure the device 205 to output the status information 245 in accordance with an indication sent via the VSF pins.

As indicated above, FIG. 2 is provided as an example. Other examples may differ from what is described with regard to FIG. 2. The number and arrangement of devices and components shown in FIG. 2 are provided as an example, and there may be additional devices, fewer devices, different devices, or differently arranged devices than those shown in FIG. 2.

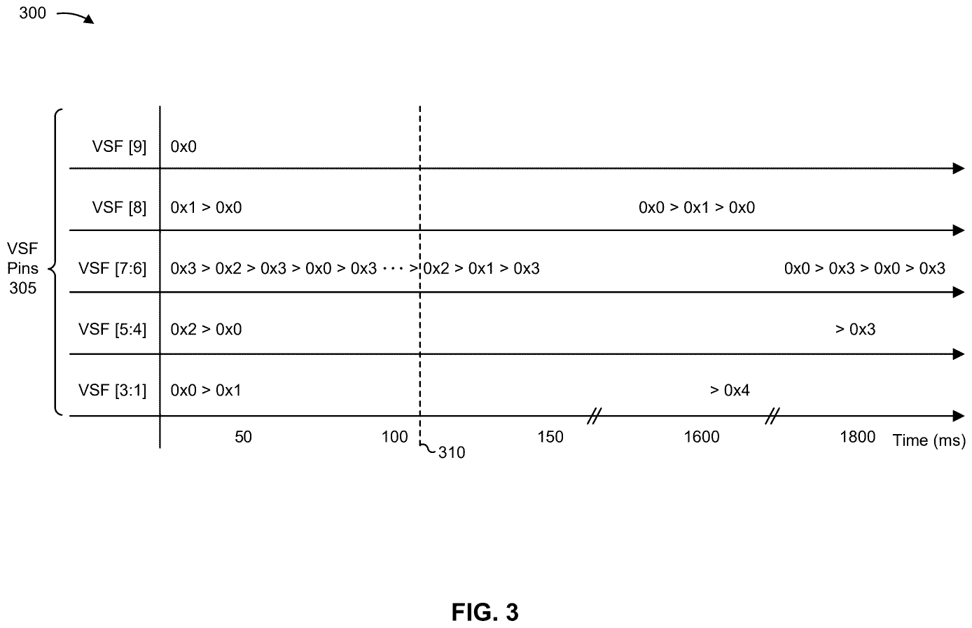

FIG. 3 is a diagram of an example 300 of monitoring information output via a set of VSF pins 305. The operations described in connection with FIG. 3 may be performed by the device 205, the memory system 110 and/or one or more components of the memory system 110, such as the memory system controller 115, one or more memory devices 120, and/or one or more local controllers 125.

The example 300 illustrates the outputting of monitoring information from the set of VSF pins 305 during a monitoring mode, as described herein with respect to FIG. 2. For example, a device (e.g., the device 205, or the memory system 110) may include at least nine VSF pins 305. In some aspects, the device may be configured to output an indication of an interface gear status via a first three VSF pins 305, shown as VSF [3:1]. In some examples, the interface gear status may correspond to a transmission rate (e.g., a transmission frequency, which may be in Gigahertz) of an interface (e.g., the interface 235) of the device. For example, the VSF [3:1] pins may be used to indicate up to six different interface gear status (e.g., by indicating values 0x0 to 0x5). In some examples, a first value (e.g., 0x0) indicated via the VSF [3:1] pins may correspond to a PWM mode, a second value (e.g., 0x1) may correspond to a Gear1 mode, a third value (e.g., 0x2) may correspond to a Gear2 mode, and a fourth value (e.g., 0x3) may correspond to a Gear3 mode.

Additionally, a fifth value (e.g., 0x4) indicated via the VSF [3:1] pins may correspond to a Gear4 mode (e.g., a Gear4x1 mode or a Gear4x2 mode) and a sixth value (e.g., 0x5) may correspond to a Gear5 mode (e.g., a Gear 5x1 mode or a Gear 5x2 mode), without differentiating between single-lane transmission or dual-lane transmission. Alternatively, additional bits may be allocated for indicating the interface gear status, which may allow for differentiating between a single-lane transmission Gear4x1 mode and a dual-lane transmission Gear4x2 mode or between a single-lane transmission Gear5x1 mode and a dual-lane transmission Gear5x2 mode. In some aspects, when the device is initialized (e.g., after the device is powered on), the device may begin in the PWM mode and indicate the first value (e.g., 0x0) via the VSF [3:1] pins, and subsequently indicate the second value (e.g., 0x1) when switching to a transmission speed corresponding to Gear1. Accordingly, a user may be able to detect error conditions relating to only one transmission lane being used instead of two transmission lanes. In some examples, each gear mode

In some aspects, the device may be configured to indicate an address range of a most recent read or write operation via two VSF pins 305, shown as VSF [5:4]. For example, the VSF [5:4] pins may be used to indicate one of four address ranges. In some aspects, a first value (e.g., 0x0) indicated via the VSF [5:4] pins may correspond to a first boot LU (e.g., boot LU 1 or Boot1), a second value (e.g., 0x1) may correspond to a second boot LU (e.g., boot LU 2 or Boot2), a third value (e.g., 0x2) may correspond to a replay protected memory range, and a fourth value (e.g., 0x4) may correspond to user area LUs. In some aspects, when the device is initialized (e.g., after the device is powered on), the device may default to indicating the third value (e.g., 0x2), which may be used to indicate when the device begins a boot process as the second value may be cleared after the boot process beings. For example, the device may indicate the first value (e.g., 0x0) while the boot process is occurring.

In some aspects, the device may be configured to indicate a command status via two VSF pins 305, shown as VSF [7:6], and the VSF [7:6] pins may be used to indicate four different command statuses. In some aspects, a first value (e.g., 0x0) indicated via the VSF [7:6] pins may correspond to a read command being performed by the device (e.g., being in transmission via an interface or I/O block of the device), a second value (e.g., 0x1) may correspond to a write command being performed by the device, a third value (e.g., 0x2) may correspond to other commands (e.g., other than read or write commands) being performed by the device, and a fourth value (e.g., 0x4) may correspond to no command being performed by the device (e.g., no data being in transmission).

As shown by FIG. 3, when the device is initialized, the device may indicate the fourth value to indicate no command is being performed, and the device may subsequently output values via the VSF [7:6] pins corresponding to a command being performed by the device. Accordingly, the VSF [7:6] pins may allow a user to identify whether read or write is being performed by the device, which may be difficult to perform using external test devices such as an oscilloscope. Additionally, or alternatively, a first non-read command issued after read commands to the boot area may indicate an end of a boot area access. For example, at time 310, the device may indicate the third value (e.g., 0x2) via the VSF [7:6] pins, which may indicate the end of the boot area access.

In some aspects, the device may be configured to indicate a completion status associated with an initialization phase of the device via one VSF pin 305, shown as VSF. For example, a first value (e.g., 0x0) indicated via the VSF [8] pin may correspond to the initialization phase being completed and the device being ready to receive commands from the host device. Additionally, a second value (e.g., 0x1) indicated via the VSF [8] pin may correspond to the initialization phase not being completed (e.g., being currently performed, or possibly not completed due to one or more errors). As shown by FIG. 3, when the device is initialized, the device may indicate the second value (e.g., 0x1) via the VSF [8] pin to indicate that the initialization phase is being performed, and the device may subsequently output the first value (e.g., 0x0) via the VSF [8] pin when the initialization phase is completed. Accordingly, the VSF [8] pin may be used for troubleshooting, as the device may indicate when the device is unavailable to perform commands due to performing the initialization phase. Conversely, when a command sent to the device is not performed and the device is indicating that the initialization phase is completed, the VSF [8] pin may indicate that a problem associated with execution of the command is unrelated to the initialization phase.

In some aspects, the device may be configured to indicate UECC information associated with an initialization phase of the device via one VSF pin 305, shown as VSF. For example, a first value (e.g., 0x0) indicated via the VSF [9] pin may indicate that there was not a UECC occurrence during a most recent read operation. Additionally, a second value (e.g., 0x1) indicated via the VSF [9] pin may indicate that there was a UECC occurrence during the most recent read operation. Accordingly, the output of the VSF [9] pin may be used to easily detect UECC occurrences.

The device may continue to output signals via the VSF pins 305 corresponding to status information of the device, as shown in FIG. 3. For example, the device may indicate the second value (e.g., 0x1) via the VSF [8] pin to indicate an additional initialization phase being performed or a period during which the device is not ready to accept commands from the host device, and the device may subsequently output the first value (e.g., 0x0) via the VSF [8] pin when the additional initialization phase is completed and/or the device is ready to accept commands from the host device. Additionally, the device may indicate the fifth value (e.g., 0x4) via the VSF [3:1] pins to indicate a change in the transmission speed of the device corresponding to a Gear4 mode.

In some examples, the device may continue to indicate command status changes via the VSF [7:6] pins in accordance with the updated transmission speed. Additionally, the device may output the fourth value (e.g., 0x3) via the VSF [5:4] pins to indicate that the device is performing operations on user area LUs. Accordingly, the VSF [5:4] pins may indicate when a first command is performed for accessing user data.

As indicated above, FIG. 3 is provided as an example. Other examples may differ from what is described with regard to FIG. 3.

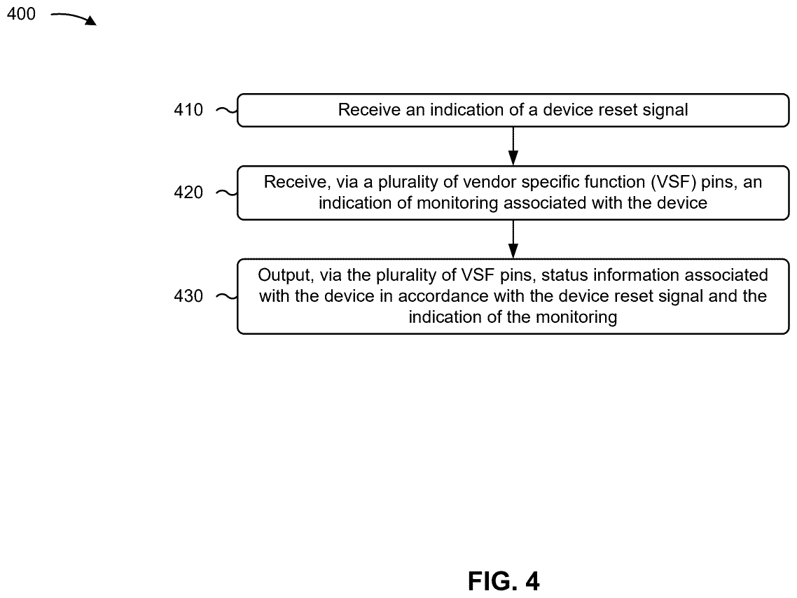

FIG. 4 is a flowchart of an example method 400 associated with a UFS user monitoring interface. In some implementations, a device (e.g., the device 205) may perform or may be configured to perform the method 400. In some implementations, another device or a group of devices separate from or including the device (e.g., the memory system 110 may perform or may be configured to perform the method 400. Additionally, or alternatively, one or more components of the device (e.g., the memory system controller 115, or a local controller 125) may perform or may be configured to perform the method 400. Thus, means for performing the method 400 may include the device and/or one or more components of the device. Additionally, or alternatively, a non-transitory computer-readable medium may store one or more instructions that, when executed by the device, cause the device to perform the method 400.

As shown in FIG. 4, the method 400 may include receiving an indication of a device reset signal (block 410). As further shown in FIG. 4, the method 400 may include receiving, via a plurality of VSF pins, an indication of monitoring associated with the device (block 420). As further shown in FIG. 4, the method 400 may include outputting, via the plurality of VSF pins, status information associated with the device in accordance with the device reset signal and the indication of the monitoring (block 430).

The method 400 may include additional aspects, such as any single aspect or any combination of aspects described below and/or described in connection with one or more other methods or operations described elsewhere herein.

In a first aspect, the method 400 includes outputting an indication of an interface gear status corresponding to a transmission rate via at least a portion of the plurality of VSF pins.

In a second aspect, alone or in combination with the first aspect, the interface gear status indicates at least one of a single lane transmission mode or a dual lane transmission mode.

In a third aspect, alone or in combination with one or more of the first and second aspects, the method 400 includes outputting an indication of an address range corresponding to a latest read operation via a portion of the plurality of VSF pins.

In a fourth aspect, alone or in combination with one or more of the first through third aspects, the method 400 includes outputting an indication of an address range corresponding to a latest write operation via a portion of the plurality of VSF pins.

In a fifth aspect, alone or in combination with one or more of the first through fourth aspects, the method 400 includes outputting an indication of a command status associated with data being transmitted via a portion of the plurality of VSF pins.

In a sixth aspect, alone or in combination with one or more of the first through fifth aspects, the command status indicates at least one of read command data being transmitted, write command data being transmitted, other command data being transmitted, or no data being transmitted.

In a seventh aspect, alone or in combination with one or more of the first through sixth aspects, the method 400 includes outputting an indication of a completion status associated with a device initialization phase via a portion of the plurality of VSF pins.

In an eighth aspect, alone or in combination with one or more of the first through seventh aspects, the method 400 includes outputting an indication of whether a latest read operation included a UECC operation.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

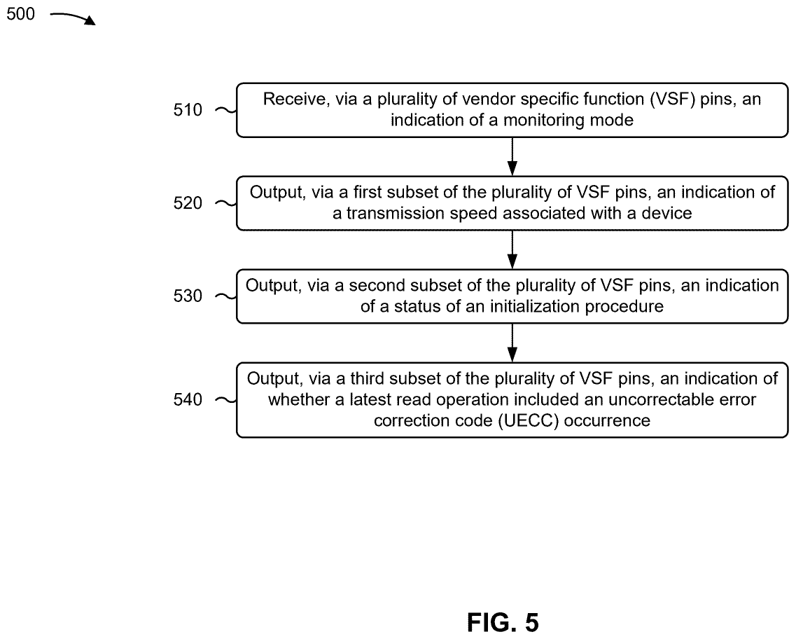

FIG. 5 is a flowchart of an example method 500 associated with a UFS user monitoring interface. In some implementations, a device (e.g., the device 205) may perform or may be configured to perform the method 500. In some implementations, another device or a group of devices separate from or including the device (e.g., memory system 110 may perform or may be configured to perform the method 500. Additionally, or alternatively, one or more components of the device (e.g., the memory system controller 115, or a local controller 125) may perform or may be configured to perform the method 500. Thus, means for performing the method 500 may include the device and/or one or more components of the device. Additionally, or alternatively, a non-transitory computer-readable medium may store one or more instructions that, when executed by the device, cause the device to perform the method 500.

As shown in FIG. 5, the method 500 may include receiving, via a plurality of VSF pins, an indication of monitoring (block 510). As further shown in FIG. 5, the method 500 may include outputting, via a first subset of the plurality of VSF pins, an indication of a transmission speed associated with a device (block 520). As further shown in FIG. 5, the method 500 may include outputting, via a second subset of the plurality of VSF pins, an indication of a status of an initialization procedure (block 530). As further shown in FIG. 5, the method 500 may include outputting, via a third subset of the plurality of VSF pins, an indication of whether a latest read operation included a UECC occurrence (block 540).

The method 500 may include additional aspects, such as any single aspect or any combination of aspects described below and/or described in connection with one or more other methods or operations described elsewhere herein.

In a first aspect, the method 500 includes outputting, via a fourth subset of the plurality of VSF pins, an indication of an address range corresponding to the latest read operation or a latest write operation.

In a second aspect, alone or in combination with the first aspect, the method 500 includes outputting, via a fifth subset of the plurality of VSF pins, an indication of a command status associated with data being transmitted.

In a third aspect, alone or in combination with one or more of the first and second aspects, the indication of the transmission speed, the indication of the status of the initialization procedure, the indication of whether the latest read operation included a UECC occurrence, the indication of the address range, and the indication of the command status are outputted concurrently.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

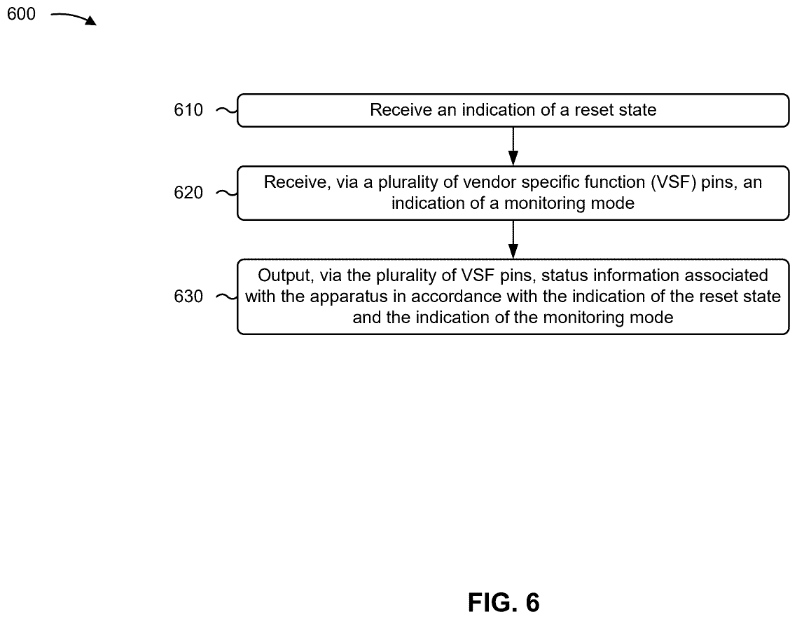

FIG. 6 is a flowchart of an example method 600 associated with a UFS user monitoring interface. In some implementations, a device (e.g., the device 205) may perform or may be configured to perform the method 600. In some implementations, another device or a group of devices separate from or including the device (e.g., memory system 110 may perform or may be configured to perform the method 600. Additionally, or alternatively, one or more components of the device (e.g., the memory system controller 115, or a local controller 125) may perform or may be configured to perform the method 600. Thus, means for performing the method 600 may include the device and/or one or more components of the device. Additionally, or alternatively, a non-transitory computer-readable medium may store one or more instructions that, when executed by the device, cause the device to perform the method 600.

As shown in FIG. 6, the method 600 may include receiving an indication of a reset state (block 610). As further shown in FIG. 6, the method 600 may include receiving, via a plurality of VSF pins, an indication of monitoring (block 620). As further shown in FIG. 6, the method 600 may include outputting, via the plurality of VSF pins, status information associated with the apparatus in accordance with the indication of the reset state and the indication of the monitoring (block 630).

The method 600 may include additional aspects, such as any single aspect or any combination of aspects described below and/or described in connection with one or more other methods or operations described elsewhere herein.

In a first aspect, the status information includes at least one of an indication of a transmission speed associated with the apparatus, an indication of a status of an initialization procedure, an indication of whether a latest read operation included an uncorrectable error correcting code (UECC) occurrence, an indication of an address range associated with a latest read operation or a latest write operation, or an indication of a command status associated with a current command.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

In some implementations, a device includes one or more components configured to: receive an indication of a device reset signal; receive, via a plurality of VSF pins, an indication of monitoring associated with the device; and output, via the plurality of VSF pins, status information associated with the device in accordance with the device reset signal and the indication of the monitoring.

In some implementations, a system comprising: a host device comprising one or more first components configured to: transmit an indication of a device reset signal; and transmit, via a plurality of VSF pins, an indication of monitoring; and a device comprising one or more second components configured to: output, via the plurality of VSF pins, status information associated with the device in accordance with the device reset signal and the indication of the monitoring.

In some implementations, a method includes receiving, via a plurality of VSF pins, an indication of monitoring; outputting, via a first subset of the plurality of VSF pins, an indication of a transmission speed associated with a device; outputting, via a second subset of the plurality of VSF pins, an indication of a status of an initialization procedure; and outputting, via a third subset of the plurality of VSF pins, an indication of whether a latest read operation included a UECC occurrence.

In some implementations, an apparatus includes means for receiving an indication of a reset state; and means for receiving, via a plurality of VSF pins, an indication of monitoring; and means for outputting, via the plurality of VSF pins, status information associated with the apparatus in accordance with the indication of the reset state and the indication of the monitoring.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device, comprising:
one or more components configured to:
receive an indication of a device reset signal;
receive, via a plurality of vendor specific function (VSF) pins, an indication of monitoring associated with the device; and
output, via the plurality of VSF pins, status information associated with the device in accordance with the device reset signal and the indication of the monitoring.

2. The device of claim 1, wherein, to output the status information, the one or more components are configured to:
output an indication of an interface gear status corresponding to a transmission rate via at least a portion of the plurality of VSF pins.

3. The device of claim 2, wherein the interface gear status indicates at least one of a single lane transmission mode or a dual lane transmission mode.

4. The device of claim 1, wherein, to output the status information, the one or more components are configured to:
output an indication of an address range corresponding to a latest read operation via a portion of the plurality of VSF pins.

5. The device of claim 1, wherein, to output the status information, the one or more components are configured to:
output an indication of an address range corresponding to a latest write operation via a portion of the plurality of VSF pins.

6. The device of claim 1, wherein, to output the status information, the one or more components are configured to:
output an indication of a command status associated with data being transmitted via a portion of the plurality of VSF pins.

7. The device of claim 6, wherein the command status indicates at least one of read command data being transmitted, write command data being transmitted, other command data being transmitted, or no data being transmitted.

8. The device of claim 1, wherein, to output the status information, the one or more components are configured to:
output an indication of a completion status associated with a device initialization phase via a portion of the plurality of VSF pins.

9. The device of claim 1, wherein, to output the status information, the one or more components are configured to:
output an indication of whether a latest read operation included an uncorrectable error correction code (UECC) operation.

10. A system comprising:
a host device comprising one or more first components configured to:
transmit an indication of a device reset signal; and
transmit, via a plurality of vendor specific function (VSF) pins, an indication of monitoring; and
a device comprising one or more second components configured to:
output, via the plurality of VSF pins, status information associated with the device in accordance with the device reset signal and the indication of the monitoring.

11. The system of claim 10, wherein, to transmit the indication of the monitoring mode, the one or more first components are configured to:
output one or more high signals via a first subset of the VSF pins; and
output one or more low signals via a second subset of the VSF pins.

12. The system of claim 10, wherein, to output the status information, the one or more second components are configured to:
output an indication of an interface gear status corresponding to a transmission rate via at least a portion of the plurality of VSF pins.

13. The system of claim 12, wherein the interface gear status indicates at least one of a single lane transmission mode or a dual lane transmission mode.

14. The system of claim 10, wherein, to output the status information, the one or more second components are configured to:
output an indication of an address range corresponding to a latest read operation via a portion of the plurality of VSF pins.

15. The system of claim 10, wherein, to output the status information, the one or more second components are configured to:
output an indication of an address range corresponding to a latest write operation via a portion of the plurality of VSF pins.

16. The system of claim 10, wherein, to output the status information, the one or more second components are configured to:
output an indication of a command status associated with data being transmitted via a portion of the plurality of VSF pins.

17. The system of claim 16, wherein the command status indicates at least one of read command data being transmitted, write command data being transmitted, other command data being transmitted, or no data being transmitted.

18. The system of claim 10, wherein, to output the status information, the one or more second components are configured to:
output an indication of a completion status associated with a device initialization phase via a portion of the plurality of VSF pins.

19. The system of claim 10, wherein, to output the status information, the one or more second components are configured to:
output an indication of whether a latest read operation included an uncorrectable error correction code (UECC) operation.

20. A method, comprising:
receiving, via a plurality of vendor specific function (VSF) pins, an indication of monitoring;
outputting, via a first subset of the plurality of VSF pins, an indication of a transmission speed associated with a device;
outputting, via a second subset of the plurality of VSF pins, an indication of a status of an initialization procedure; and
outputting, via a third subset of the plurality of VSF pins, an indication of whether a latest read operation included an uncorrectable error correction code (UECC) occurrence.

21. The method of claim 20, further comprising:
outputting, via a fourth subset of the plurality of VSF pins, an indication of an address range corresponding to the latest read operation or a latest write operation.

22. The method of claim 21, further comprising:
outputting, via a fifth subset of the plurality of VSF pins, an indication of a command status associated with data being transmitted.

23. The method of claim 22, wherein the indication of the transmission speed, the indication of the status of the initialization procedure, the indication of whether the latest read operation included a UECC occurrence, the indication of the address range, and the indication of the command status are outputted concurrently.

24. An apparatus, comprising:
means for receiving an indication of a reset state; and
means for receiving, via a plurality of vendor specific function (VSF) pins, an indication of a monitoring mode; and
means for outputting, via the plurality of VSF pins, status information associated with the apparatus in accordance with the indication of the reset state and the indication of the monitoring mode.

25. The apparatus of claim 24, wherein the status information includes at least one of an indication of a transmission speed associated with the apparatus, an indication of a status of an initialization procedure, an indication of whether a latest read operation included an uncorrectable error correcting code (UECC) occurrence, an indication of an address range associated with a latest read operation or a latest write operation, or an indication of a command status associated with a current command.
